(19) United States
(12) Patent Application Publication
(10) Pub. No.: US 2024/0300524 A1
(43) Pub. Date: Sep. 12, 2024

(54) VEHICLE CONTROL DEVICE, VEHICLE CONTROL METHOD, AND STORAGE MEDIUM

(71) Applicant: HONDA MOTOR CO., LTD., Minato-ku, Tokyo (JP)

(72) Inventors: Sho Hitakatsu, Wako-shi, Saitama (JP); Toshikazu Suwa, Tokyo (JP); Masaki Nakajima, Yokohama-shi (JP)

(21) Appl. No.: 18/268,619

(22) PCT Filed: Dec. 28, 2020
(86) PCT No.: PCT/JP2020/049079

§ 371 Date: Jun. 21, 2023

(51) Int. Cl. B60W 60/00; B60W 30/182

(52) U.S. Cl. CPC B60W 60/001; B60W 30/182; B60W 2420/40; B60W 2552/10; B60W 2720/106

(57) ABSTRACT

A vehicle control device includes a recognizer configured to recognize a surrounding situation of a vehicle, a driving controller configured to control steering, acceleration, and deceleration of the vehicle independently of an operation of a driver of the vehicle, and a mode decider configured to decide on a driving mode of the vehicle as one of a plurality of driving modes including a first driving mode and a second driving mode. The recognizer recognizes an available travel lane in the same direction as the vehicle located inside of a reference range. The mode decider changes the driving mode of the vehicle from the second driving mode to the first driving mode on the basis of the number of lanes recognized by the recognizer when the driving mode of the vehicle is the second driving mode.

### TECHNICAL FIELD

The present invention relates to a vehicle control device, a vehicle control method, and a program.

### BACKGROUND ART

In the related art, an invention of an in-vehicle system including a storage determination processor configured to iteratively determine the presence or absence of high-precision map information about a road through which a host vehicle has passed, a storage information acquisition processor configured to acquire information indicating iterated determination results, and an automated driving possibility notifier configured to provide a notification of information acquired by the storage information acquisition processor is disclosed (Patent Document 1).

### CITATION LIST

### Patent Document

### [Patent Document 1]

Japanese Unexamined Patent Application, First Publication No. 2018-189594

### SUMMARY OF INVENTION

### Technical Problem

Although the information stored in the map is used to mechanically provide a notification of the possibility of automated driving in the related art, an actual traffic situation is more complicated and it may be difficult to perform appropriate control corresponding to a road structure.

The present invention has been made in consideration of such circumstances and an objective of the present invention is to provide a vehicle control device, a vehicle control method, and a program capable of performing appropriate control corresponding to a road structure.

### Solution to Problem

A vehicle control device, a vehicle control method, and a program according to the present invention adopt the following configurations.

(1): According to an aspect of the present invention, there is provided a vehicle control device including: a recognizer configured to recognize a surrounding situation of a vehicle: a driving controller configured to control steering, acceleration, and deceleration of the vehicle independently of an operation of a driver of the vehicle; and a mode decider configured to decide on a driving mode of the vehicle as one of a plurality of driving modes including a first driving mode and a second driving mode and change the driving mode of the vehicle to a driving mode having a heavier task when a task related to the decided driving mode is not executed by the driver, wherein the second driving mode is a driving mode having a lighter task imposed on the driver than the first driving mode and some of the plurality of driving modes including at least the second driving mode are controlled by the driving controller, wherein the recognizer recognizes an available travel lane in the same direction as the vehicle located inside of a reference range, and wherein the mode decider changes the driving mode of the vehicle from the second driving mode to the first driving mode on the basis of the number of lanes recognized by the recognizer when the driving mode of the vehicle is the second driving mode.

(2): In the above-described aspect (1), the mode decider changes the driving mode in the driving controller from the second driving mode to the first driving mode when the number of lanes exceeds a first reference value.

(3): In the above-described aspect (1), the mode decider changes the driving mode in the driving controller from the second driving mode to the first driving mode when the number of lanes exceeds a second reference value and the number of lanes located inside of a range near the vehicle recognized by the recognizer exceeds a third reference value.

(4): In the above-described aspect (1), the reference range includes a range from the vehicle to a forward reference distance in a forward direction and a range from the vehicle to a rearward reference distance in a rearward direction.

(5): In the above-described aspect (4), the forward reference distance is longer than the rearward reference distance.

(6): According to an aspect of the present invention, there is provided a vehicle control device including: a recognizer configured to recognize a surrounding situation of a vehicle; a driving controller configured to control steering, acceleration, and deceleration of the vehicle independently of an operation of a driver of the vehicle; and a mode decider configured to decide on a driving mode of the vehicle as one of a plurality of driving modes including a first driving mode and a second driving mode and change the driving mode of the vehicle to a driving mode having a heavier task when a task related to the decided driving mode is not executed by the driver, wherein the second driving mode is a driving mode having a lighter task imposed on the driver than the first driving mode and some of the plurality of driving modes including at least the second driving mode are controlled by the driving controller, wherein the recognizer recognizes a branch point in an available travel lane in the same direction as the vehicle located inside of a reference range, and wherein the mode decider changes the driving mode of the vehicle from the second driving mode to the first driving mode when the driving mode of the vehicle is the second driving mode and the number of branch points recognized by the recognizer exceeds a fourth reference value.

(7): In the above-described aspect (1) or (6), the second driving mode is a driving mode in which at least gripping of an operation element for receiving a steering operation from the driver is not imposed, and the first driving mode is a driving mode in which at least one driving operation by the driver within the steering, the acceleration, and the deceleration of the vehicle is required or a driving mode in which gripping of the operation element by the driver is imposed.

(8): According to an aspect of the present invention, there is provided a vehicle control method including: recognizing, by a computer mounted in a vehicle, a surrounding situation of the vehicle: controlling, by the computer, steering, acceleration, and deceleration of the vehicle independently of an operation of a driver of the vehicle: deciding, by the computer, on a driving mode of the vehicle as one of a plurality of driving modes including a first driving mode and a second driving mode, wherein the second driving mode is a driving mode having a lighter task imposed on the driver than the first driving mode, and performing some of the plurality of driving modes including at least the second driving mode by controlling the steering, the acceleration, and the deceleration of the vehicle independently of the operation of the driver of the vehicle: changing, by the computer, the driving mode of the vehicle to a driving mode having a heavier task when a task related to the decided driving mode is not executed by the driver; recognizing, by the computer, an available travel lane in the same direction as the vehicle located inside of a reference range at the time of the recognition; and changing, by the computer, the driving mode of the vehicle from the second driving mode to the first driving mode on the basis of the number of recognized lanes when the driving mode of the vehicle is the second driving mode.

(9): According to an aspect of the present invention, there is provided a vehicle control method including: recognizing, by a computer mounted in a vehicle, a surrounding situation of the vehicle: controlling, by the computer, steering, acceleration, and deceleration of the vehicle independently of an operation of a driver of the vehicle: deciding, by the computer, on a driving mode of the vehicle as one of a plurality of driving modes including a first driving mode and a second driving mode, wherein the second driving mode is a driving mode having a lighter task imposed on the driver than the first driving mode, and performing some of the plurality of driving modes including at least the second driving mode by controlling the steering, the acceleration, and the deceleration of the vehicle independently of the operation of the driver of the vehicle: changing, by the computer, the driving mode of the vehicle to a driving mode having a heavier task when a task related to the decided driving mode is not executed by the driver; recognizing, by the computer, a branch point in an available travel lane in the same direction as the vehicle located inside of a reference range at the time of the recognition; and changing, by the computer, the driving mode of the vehicle from the second driving mode to the first driving mode when the driving mode of the vehicle is the second driving mode and the number of recognized branch points exceeds a fourth reference value.

(10): According to an aspect of the present invention, there is provided a program for causing a computer mounted in a vehicle to: recognize a surrounding situation of the vehicle: control steering, acceleration, and deceleration of the vehicle independently of an operation of a driver of the vehicle; decide on a driving mode of the vehicle as one of a plurality of driving modes including a first driving mode and a second driving mode, wherein the second driving mode is a driving mode having a lighter task imposed on the driver than the first driving mode, and perform some of the plurality of driving modes including at least the second driving mode by controlling the steering, the acceleration, and the deceleration of the vehicle independently of the operation of the driver of the vehicle: change the driving mode of the vehicle to a driving mode having a heavier task when a task related to the decided driving mode is not executed by the driver: recognize an available travel lane in the same direction as the vehicle located inside of a reference range at the time of the recognition; and change the driving mode of the vehicle from the second driving mode to the first driving mode on the basis of the number of recognized lanes when the driving mode of the vehicle is the second driving mode.

(11): According to an aspect of the present invention, there is provided a program for causing a computer mounted in a vehicle to: recognize a surrounding situation of the vehicle; control steering, acceleration, and deceleration of the vehicle independently of an operation of a driver of the vehicle; decide on a driving mode of the vehicle as one of a plurality of driving modes including a first driving mode and a second driving mode, wherein the second driving mode is a driving mode having a lighter task imposed on the driver than the first driving mode, and perform some of the plurality of driving modes including at least the second driving mode by controlling the steering, the acceleration, and the deceleration of the vehicle independently of the operation of the driver of the vehicle: change the driving mode of the vehicle to a driving mode having a heavier task when a task related to the decided driving mode is not executed by the driver: recognize a branch point in an available travel lane in the same direction as the vehicle located inside of a reference range at the time of the recognition; and change the driving mode of the vehicle from the second driving mode to the first driving mode when the driving mode of the vehicle is the second driving mode and the number of recognized branch points exceeds a fourth reference value.

### Advantageous Effects of Invention

According to the above-described aspects (1) to (11), it is possible to perform appropriate control corresponding to a road structure.

### BRIEF DESCRIPTION OF DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of corresponding relationships between driving modes, control states of a host vehicle, and tasks.

FIG. 4 is a diagram showing a lane recognized by a recognizer according to a first embodiment.

FIG. 5 is a flowchart showing an example of a flow of a process executed by a mode decider according to the first embodiment.

FIG. 6 is a diagram showing a case where a range of lanes recognized by the recognizer is narrowed down to a peripheral range of a host vehicle according to a second embodiment.

FIG. 7 is a flowchart showing an example of a flow of a process executed by the mode decider according to the second embodiment.

FIG. 8 is a diagram showing a branch lane recognized by a recognizer according to a third embodiment.

FIG. 9 is a flowchart showing an example of a flow of a process executed by a mode decider according to the third embodiment.

### DESCRIPTION OF EMBODIMENTS

Hereinafter, embodiments of a vehicle control device, a vehicle control method, and a program of the present invention will be described with reference to the drawings.

### [Overall Configuration]

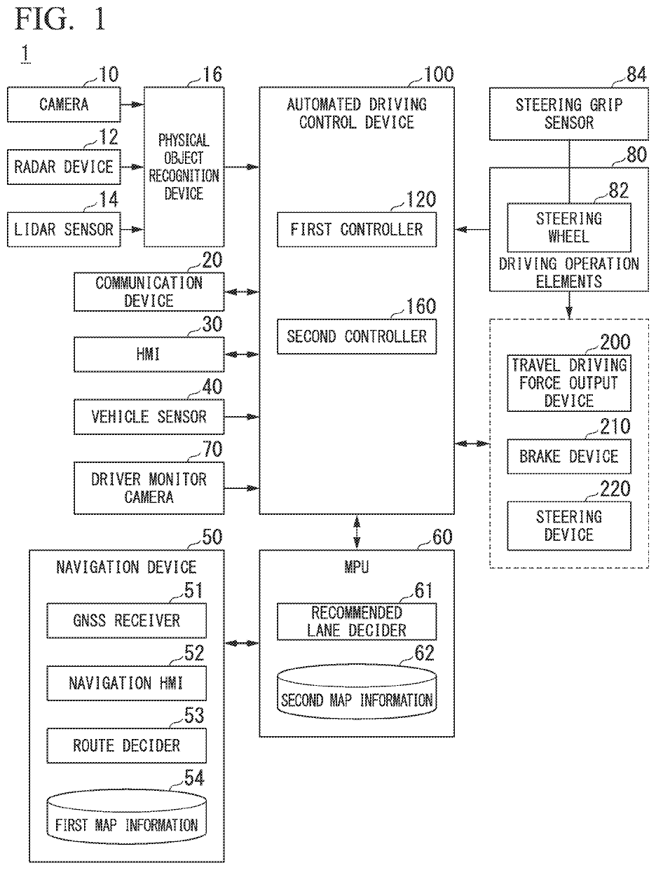

FIG. 1 is a configuration diagram of a vehicle system 1 using the vehicle control device according to the present embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery or a fuel cell is discharged.

For example, the vehicle system 1 includes a camera 10, a radar device 12, a light detection and ranging (LIDAR) sensor 14, a physical object recognition device 16, a communication device 20, a human machine interface (HMI) 30, a vehicle sensor 40, a navigation device 50, a map positioning unit (MPU) 60, a driver monitor camera 70, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the components may be omitted or other components may be further added.

For example, the camera 10 is a digital camera using a solid-state imaging element such as a charge coupled device (CCD) or a complementary metal oxide semiconductor (CMOS). The camera 10 is attached to any location on the vehicle (hereinafter, a host vehicle M) in which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any location on the host vehicle M. The radar device 12 may detect a position and speed of the physical object in a frequency modulated continuous wave (FM-CW) scheme.

The LIDAR sensor 14 radiates light (or electromagnetic waves of a wavelength close to an optical wavelength) to the vicinity of the host vehicle M and measures scattered light. The LIDAR sensor 14 detects a distance to an object on the basis of a period of time from light emission to light reception. The radiated light is, for example, pulsed laser light. The LIDAR sensor 14 is attached to any location on the host vehicle M.

The physical object recognition device 16 performs a sensor fusion process on detection results from some or all of the camera 10, the radar device 12, and the LIDAR sensor 14 to recognize a position, a type, a speed, and the like of a physical object. The physical object recognition device 16 outputs recognition results to the automated driving control device 100. The physical object recognition device 16 may output detection results of the camera 10, the radar device 12, and the LIDAR sensor 14 to the automated driving control device 100 as they are. The physical object recognition device 16 may be omitted from the vehicle system 1.

The communication device 20 communicates with another vehicle located in the vicinity of the host vehicle M using, for example, a cellular network, a Wi-Fi network, Bluetooth (registered trademark), dedicated short range communication (DSRC), or the like, or communicates with various types of server devices via a radio base station.

The HMI 30 provides an occupant of the host vehicle M with various types of information and receives an input operation from the occupant. The HMI 30 includes various types of display devices, a speaker, a buzzer, a touch panel, a switch, a key, and the like.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect the direction of the host vehicle M, and the like.

For example, the navigation device 50 includes a global navigation satellite system (GNSS) receiver 51, a navigation HMI 52, and a route decider 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route decider 53 decides on a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane decider 61 and stores second map information 62 in a storage device such as an HDD or a flash memory. The recommended lane decider 61 divides the route on the map provided from the navigation device 50 into a plurality of blocks (for example, divides the route every 100 [m] in a traveling direction of the vehicle), and decides on a recommended lane for each block with reference to the second map information 62. The recommended lane decider 61 decides in what lane numbered from the left the vehicle will travel. The recommended lane decider 61 decides on the recommended lane so that the host vehicle M can travel along a reasonable route for traveling to a branching destination when there is a branch point on the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, telephone number information, information of a prohibition section in which mode A or B to be described below is prohibited, and the like. The second map information 62 may be updated at any time when the communication device 20 communicates with another device.

The driver monitor camera 70 is, for example, a digital camera that uses a solid-state image sensor such as a CCD or a CMOS. The driver monitor camera 70 is attached to any location on the host vehicle M with respect to a position and a direction where the head of the occupant (hereinafter, the driver) sitting in the driver's seat of the host vehicle M can be imaged from the front (in a direction in which his/her face is imaged). For example, the driver monitor camera 70 is attached to an upper part of a display device provided on the central portion of the instrument panel of the host vehicle M.

For example, the driving operation elements 80 include an accelerator pedal, a brake pedal, a shift lever, and other operation elements in addition to a steering wheel 82. A sensor configured to detect an amount of operation or the presence or absence of an operation is attached to the driving operation element 80 and a detection result of the sensor is output to the automated driving control device 100 or some or all of the travel driving force output device 200, the brake device 210, and the steering device 220. The steering wheel 82 is an example of an “operation element that receives a steering operation by the driver.” The operation element does not necessarily have to be annular and may be in the form of a variant steering wheel, a joystick, a button, or the like. A steering grip sensor 84 is attached to the steering wheel 82. The steering grip sensor 84 is implemented by a capacitance sensor or the like and outputs a signal for detecting whether or not the driver is gripping the steering wheel 82 (indicating that the driver is in contact with the steering wheel 82 in a state in which a force is applied) to the automated driving control device 100.

The automated driving control device 100 includes, for example, a first controller 120 and a second controller 160. Each of the first controller 120 and the second controller 160 is implemented, for example, by a hardware processor such as a central processing unit (CPU) executing a program (software). Some or all of the above components may be implemented by hardware (including a circuit: circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as an HDD or a flash memory of the automated driving control device 100 or may be stored in a removable storage medium such as a DVD or a CD-ROM and installed in the HDD or the flash memory of the automated driving control device 100 when the storage medium (the non-transitory storage medium) is mounted in a drive device. The automated driving control device 100 is an example of a “vehicle control device” and a combination of the action plan generator 140 and the second controller 160 is an example of a “driving controller.”

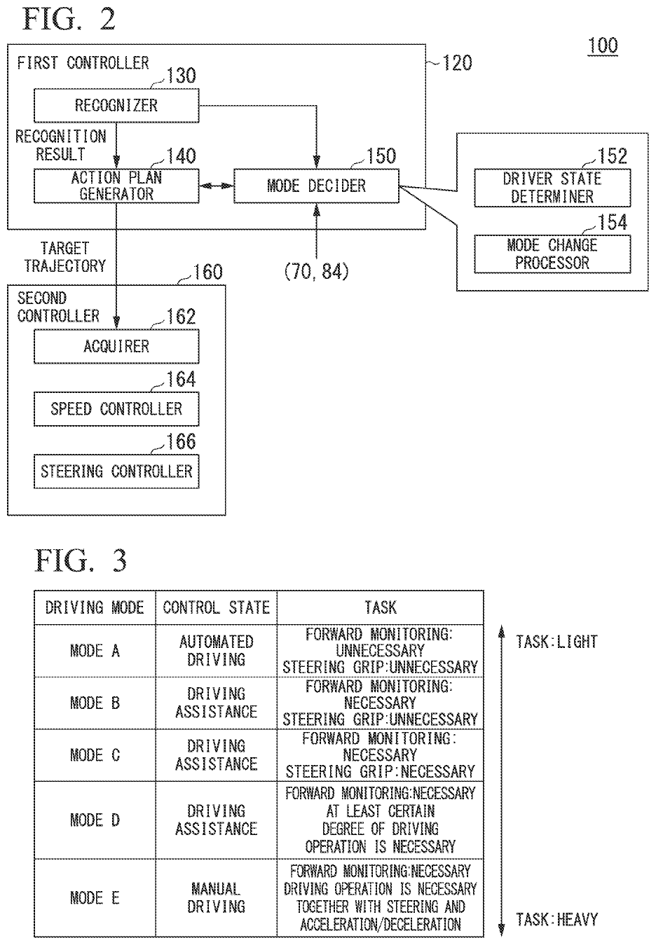

FIG. 2 is a functional configuration diagram of the first controller 120 and the second controller 160. The first controller 120 includes, for example, a recognizer 130, the action plan generator 140, and a mode decider 150. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both recognitions. Thereby, the reliability of automated driving is secured.

The recognizer 130 recognizes states of positions, speeds, acceleration, and the like of physical objects near the host vehicle M on the basis of information input from the camera 10, the radar device 12, and the LIDAR sensor 14 via the physical object recognition device 16. For example, the position of the physical object is recognized as a position on absolute coordinates with a representative point (the center of gravity, the driving shaft center, or the like) of the host vehicle M as the origin and is used for control. The position of the physical object may be represented by a representative point such as the center of gravity or a corner of the physical object or may be represented by an area. The “state” of a physical object may include acceleration or jerk of the physical object or an “action state” (for example, whether or not a lane change is being made or intended).

Also, for example, the recognizer 130 recognizes a lane in which the host vehicle M is traveling (a travel lane). For example, the recognizer 130 recognizes the travel lane by comparing a pattern of road markings (for example, an arrangement of solid lines and broken lines) obtained from the second map information 62 with a pattern of road markings in the vicinity of the host vehicle M recognized from an image captured by the camera 10. Also, the recognizer 130 may recognize the travel lane by recognizing a traveling path boundary (a road boundary) including a road marking, a road shoulder, a curb, a median strip, a guardrail, or the like as well as a road marking. In this recognition, a position of the host vehicle M acquired from the navigation device 50 or a processing result of the INS may be taken into account. The recognizer 130 recognizes a temporary stop line, an obstacle, red traffic light, a toll gate, and other road events.

When the travel lane is recognized, the recognizer 130 recognizes a position or an orientation of the host vehicle M with respect to the travel lane. For example, the recognizer 130 may recognize a gap of a reference point of the host vehicle M from the center of the lane and an angle formed with respect to a line connected to the center of the lane in the traveling direction of the host vehicle M as a relative position and orientation of the host vehicle M related to the travel lane. Alternatively, the recognizer 130 may recognize a position of the reference point of the host vehicle M related to one side end portion (a road marking or a road boundary) of the travel lane or the like as a relative position of the host vehicle M related to the travel lane.

In addition to the travel lane, the recognizer 130 recognizes, for example, a lane in which the host vehicle M can travel in a direction identical to a traveling direction of the travel lane (hereinafter referred to as a main lane), a lane branching off from the travel lane or the main lane (hereinafter referred to as a branch lane), and a lane that merges into the travel lane or the main lane (hereinafter referred to as a merging lane). The recognizer 130 recognizes a direction identical to the traveling direction of the host vehicle M, i.e., a branch lane or a merging lane in front of the host vehicle M, and a rearward branch lane or merging lane in which the host vehicle M has traveled.

The action plan generator 140 generates a future target trajectory along which the host vehicle M will automatically travel (independently of the driver's operation) so that the host vehicle M can generally travel in the recommended lane determined by the recommended lane decider 61 and further cope with a surrounding situation of the host vehicle M. For example, the target trajectory includes a speed element. For example, the target trajectory is represented by sequentially arranging points (trajectory points) at which the host vehicle M is required to arrive. The trajectory points are points at which the host vehicle M is required to arrive for each prescribed traveling distance (for example, about several meters [m]) along a road. In addition, a target speed and target acceleration for each prescribed sampling time (for example, about 0.x [sec] where x is a decimal number) are generated as parts of the target trajectory. The trajectory point may be a position at which the host vehicle M is required to arrive at the sampling time for each prescribed sampling time. In this case, information of the target speed or the target acceleration is represented by an interval between the trajectory points.

The action plan generator 140 may set an automated driving event when a target trajectory is generated. Automated driving events include a constant-speed traveling event, a low-speed tracking traveling event, a lane change event, a branch-point-related movement event, a merging-point-related movement event, a takeover event, and the like. The action plan generator 140 generates a target trajectory according to an activated event.

The mode decider 150 decides on a driving mode of the host vehicle M as one of a plurality of driving modes. The plurality of driving modes have different tasks imposed on the driver. The mode decider 150 includes, for example, a driver state determiner 152 and a mode change processor 154. These individual functions will be described below.

FIG. 3 is a diagram showing an example of corresponding relationships between the driving modes, the control states of the host vehicle M, and the tasks. For example, there are five modes from mode A to mode E as the driving modes of the host vehicle M. A control state, i.e., the degree of automation of the driving control of the host vehicle M, is highest in mode A, lower in the order of mode B, mode C, and mode D, and lowest in mode E. In contrast, a task imposed on the driver is lightest in mode A, heavier in the order of mode B, mode C, and mode D, and heaviest in mode E. Because of a control state that is not automated driving in modes D and E, the automated driving control device 100 is responsible for ending control related to automated driving and shifting the driving mode to driving assistance or manual driving. The content of the driving modes will be exemplified below.

In mode A, in an automated driving state, neither forward monitoring nor gripping of the steering wheel 82 (a steering grip in FIG. 3) is imposed on the driver. However, even in mode A, the driver is required to be in a posture where the fast shift to manual driving is enabled in response to a request from the system centered on the automated driving control device 100. The term “automated driving” as used herein indicates that both steering and acceleration/deceleration are controlled independently of the operation of the driver. The term “forward region or direction” indicates a space in a traveling direction of the host vehicle M that is visually recognized via the front windshield. Mode A is a driving mode in which the host vehicle M travels at a prescribed speed (for example, about 50 [km/h]) or less on a motorway such as an expressway and which can be executed when a condition in which there is a tracking target preceding vehicle or the like is satisfied. Mode A may be referred to as a traffic jam pilot (TJP). When this condition is no longer satisfied, the mode decider 150 changes the driving mode of the host vehicle M to mode B.

In mode B, in a driving assistance state, a task of monitoring a forward direction of the host vehicle M (hereinafter referred to as forward monitoring) is imposed on the driver, but a task of gripping the steering wheel 82 is not imposed on the driver. In mode C, in a driving assistance state, a forward monitoring task and a task of gripping the steering wheel 82 are imposed on the driver. In mode D, a task in which a certain degree of driving operation is required for at least one of steering and acceleration/deceleration of the host vehicle M is imposed on the driver. For example, in mode D, driving assistance such as adaptive cruise control (ACC) or a lane keeping assist system (LKAS) is performed. In mode E, manual driving in which a task requiring a driving operation for both steering and acceleration/deceleration is imposed on the driver is performed. In both modes D and E, a task of monitoring a forward direction of the host vehicle M is naturally imposed on the driver.

The automated driving control device 100 (and the driving assistance device (not shown)) makes an automated lane change corresponding to the driving mode. Automated lane changes include an automated lane change (1) due to a system request and an automated lane change (2) due to a driver request. Examples of the automated lane change (1) include an automated lane change for passing and an automated lane change for traveling toward a destination (an automated lane change based on a change in a recommended lane) performed when the speed of the preceding vehicle is less than the speed of the host vehicle by a reference level or higher. In the automated lane change (2), if a condition related to a speed, a positional relationship associated with a nearby vehicle, or the like is satisfied, the host vehicle M is allowed to change the lane in an operation direction when a direction indicator has been operated by the driver.

The automated driving control device 100 does not execute either of the automated lane changes (1) and (2) in mode A. The automated driving control device 100 executes both automated lane changes (1) and (2) in modes B and C. The driving assistance device (not shown) does not execute the automated lane change (1) but executes the automated lane change (2) in mode D. In mode E, neither of the automated lane changes (1) and (2) is executed.

The mode decider 150 changes the driving mode of the host vehicle M to a driving mode in which a task is heavier when the task associated with the decided driving mode (hereinafter referred to as a current driving mode) is not executed by the driver.

For example, in mode A, when the driver is in a posture where he/she cannot shift the driving to manual driving in response to a request from the system (for example, when he/she continues to look outside an allowable area or when a sign that driving is difficult is detected), the mode decider 150 performs a control process of prompting the driver to shift the driving to manual driving using the HMI 30, causing the host vehicle M to gradually stop close to the road shoulder when the driver does not respond, and stopping the automated driving. After the automated driving is stopped, the host vehicle M is in a state of mode D or E. Thereby, the host vehicle M can be started according to the manual driving of the driver. Hereinafter, the same is true for “stopping of automated driving.” When the driver is not performing forward monitoring in mode B, the mode decider 150 performs a control process of prompting the driver to perform the forward monitoring using the HMI 30, causing the host vehicle M to gradually stop close to the road shoulder when the driver does not respond, and stopping the automated driving. When the driver is not performing forward monitoring or is not gripping the steering wheel 82 in mode C, the mode decider 150 performs a control process of prompting the driver to perform the forward monitoring and/or grip the steering wheel 82 using the HMI 30, causing the host vehicle M to gradually stop close to the road shoulder when the driver does not respond, and stopping the automated driving.

The driver state determiner 152 monitors the driver's state for the above-described mode change and determines whether or not the driver's state corresponds to the task. For example, the driver state determiner 152 performs a posture estimation process by analyzing the image captured by the driver monitor camera 70 and determines whether or not the driver is in a posture in which it is difficult to shift the driving to manual driving in response to a request from the system. The driver state determiner 152 performs a visual line estimation process by analyzing the image captured by the driver monitor camera 70 and determines whether or not the driver is performing forward monitoring.

The mode change processor 154 performs various types of processes for the mode change. For example, the mode change processor 154 instructs the action plan generator 140 to generate a target trajectory for stopping on the road shoulder, instructs a driving assistance device (not shown) to operate, or controls the HMI 30 for instructing the driver to take an action.

The second controller 160 controls the travel driving force output device 200, the brake device 210, and the steering device 220 so that the host vehicle M passes along the target trajectory generated by the action plan generator 140 at the scheduled times.

Returning to FIG. 2, the second controller 160 includes, for example, an acquirer 162, a speed controller 164, and a steering controller 166. The acquirer 162 acquires information of a target trajectory (trajectory points) generated by the action plan generator 140 and causes a memory (not shown) to store the information. The speed controller 164 controls the travel driving force output device 200 or the brake device 210 on the basis of a speed element associated with the target trajectory stored in the memory. The steering controller 166 controls the steering device 220 in accordance with the degree of curvature of the target trajectory stored in the memory. The processes of the speed controller 164 and the steering controller 166 are implemented by, for example, a combination of feedforward control and feedback control. As an example, the steering controller 166 executes feedforward control according to the curvature of the road in front of the host vehicle M and feedback control based on deviation from the target trajectory in combination.

The travel driving force output device 200 outputs a travel driving force (torque) for enabling the vehicle to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated according to an operation on the brake pedal included in the driving operation elements 80 to the cylinder via a master cylinder as a backup. The brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operation element 80 to change the direction of the steerable wheels.

One or more of modes A to C are examples of a “second driving mode” in the claims and one or more of modes C to E are examples of a “first driving mode” in the claims. Here, if mode C is the “second driving mode” in the claims, the “first driving mode” in the claims is either mode D or E. In the following description, as an example, it is assumed that the “second driving mode” in the claims is mode A or B and the “first driving mode” in the claims is mode C.

### First Embodiment

### [Control of Driving Mode]

Hereinafter, control of the driving mode of the host vehicle M corresponding to the number of lanes around the host vehicle M will be described. In the following description, when the host vehicle M is traveling in mode A or B, a case where the traveling in mode A or B is terminated and the mode is changed to mode C will be described.

The recognizer 130 recognizes a lane in which other vehicles that are likely to be involved in the driving of the host vehicle M are traveling. The recognizer 130 recognizes an available travel lane that is in a direction identical to the traveling direction of the host vehicle M and that is located within a range of a reference distance based on the host vehicle M (a reference range).

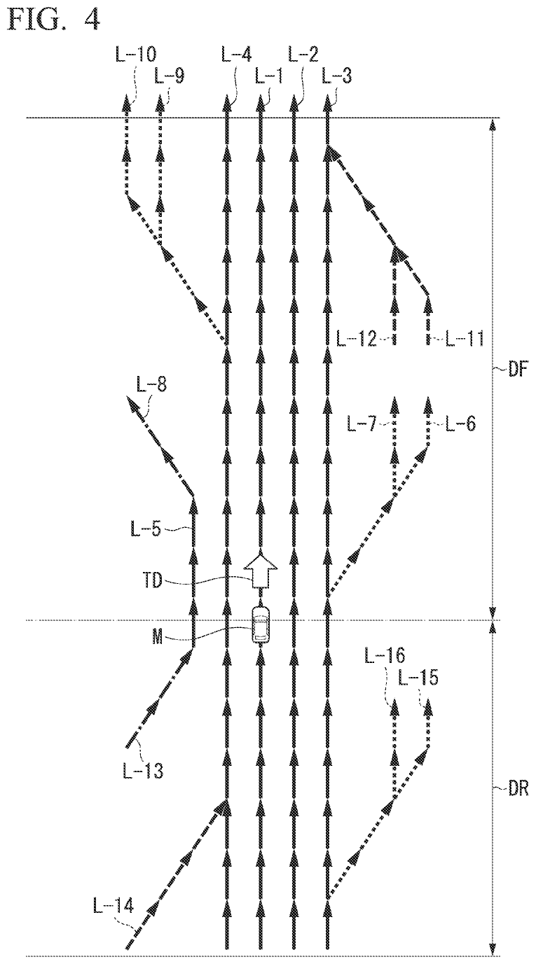

FIG. 4 is a diagram showing a lane recognized by the recognizer 130 according to the first embodiment. In FIG. 4, a series of arrows that are continuously connected indicate lanes. In this situation, the host vehicle M is traveling in a plurality of main lanes in a direction that is a traveling direction TD. The recognizer 130 recognizes a lane L located within a range of a forward reference distance DF in front of the host vehicle M and a lane L located within a range of a rearward reference distance DR behind the host vehicle M. The forward reference distance DF is longer than the rearward reference distance DR. For example, the forward reference distance DF and the rearward reference distance DR are both distances of several hundreds of meters [m].

In the example of FIG. 4, the recognizer 130 recognizes lanes L-1 to L-12 in the range of the forward reference distance DF. When the host vehicle M is at the position shown in FIG. 4, the lanes L-1 to L-5 are main lanes. Among the lanes, the lane L-1 is the travel lane of the host vehicle M and the lanes L-2 to L-5 are main lanes where the host vehicle M can travel in the same direction as the travel lane of the host vehicle M. The lanes L-6 to L-10 are branch lanes that branch off from the main lane. The lanes L-11 and L-12 are merging lanes that merge into the main lane.

The recognizer 130 recognizes lanes L-13 to L-16 in the range of the rearward reference distance DR. At this time, the recognizer 130 does not recognize the lanes L-1 to L-5 already recognized at the forward reference distance DF at the rearward reference distance DR. When the host vehicle M is at the position shown in FIG. 4, the lanes L-13 and L-14 are merging lanes that merge into the main lane. The lanes L-15 and L-16 are branch lanes that branch off from the main lane.

The recognizer 130 outputs information of the recognized lane (hereinafter referred to as lane information) to the mode decider 150. The lane information includes at least information of the number of recognized lanes L (hereinafter referred to as the number of lanes). The lane information may include, for example, lane classification information indicating whether each recognized lane L is a main lane, a branch lane, or a merging lane, lane position information indicating a positional relationship associated with the host vehicle M indicating whether the lane L is a lane located in the range of either the forward reference distance DF or the rearward reference distance DR, and a distance from the position of the host vehicle M in each lane L (which may include forward or rearward information), and the like.

The mode decider 150 changes the driving mode of the host vehicle M on the basis of the lane information output by the recognizer 130. More specifically, the mode decider 150 determines whether the current driving mode of the host vehicle M is mode A or B and whether or not the number of lanes included in the lane information exceeds the first reference value. The first reference value is, for example, a value of the number of lanes that are about several lanes to several tens of lanes. The first reference value may be a fixed value or may be determined in accordance with a situation in which the host vehicle M is currently traveling such as the speed at which the host vehicle M is traveling, the presence or absence of other vehicles traveling in the same travel lane or the main lane, or the number of main lanes.

When the driving mode of the host vehicle M is mode A or B and the number of lanes exceeds the first reference value, the mode decider 150 changes the current driving mode of the host vehicle M from mode A or B to mode C. Thereby, the driver performs forward monitoring and grips the steering wheel 82 when passing through a range where the number of lanes exceeds the first reference value. Thereby, even if there is a change in the surrounding environment, the driver can respond by operating the steering wheel 82 by himself/herself.

The mode decider 150 may change the driving mode from mode A or B to mode D or E instead of changing the driving mode from mode A or B to mode C. In this case, the mode decider 150 may temporarily change the mode to mode C and then change the mode to mode D or E until the driving mode is changed from mode A or B to mode D or E.

The mode decider 150 may change the driving mode changed to mode C to mode A or B again on condition that the number of lanes included in the lane information output by the recognizer 130 becomes less than or equal to the first reference value. Thereby, the convenience in the host vehicle M can be improved. The mode decider 150 may be configured to prompt the driver to operate the HMI 30 as a condition for changing the driving mode from mode C to mode A or B. Thereby, it is possible to suppress control disturbance due to switching of the driving mode.

### [Driving Mode Change Process]

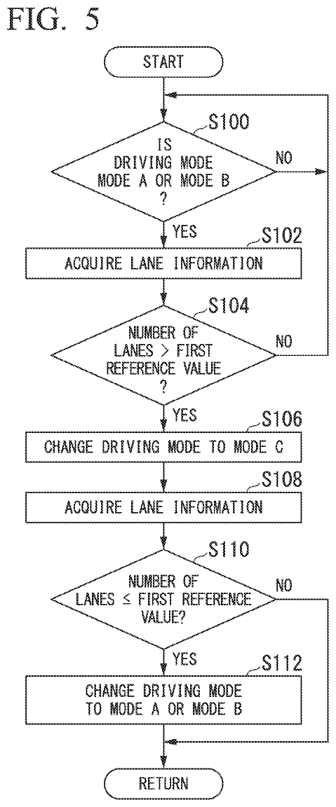

FIG. 5 is a flowchart showing an example of a flow of a process executed by the mode decider 150 according to the first embodiment. The change process of the flowchart is iteratively executed, for example, when the automated driving control device 100 is operating.

First, the mode decider 150 determines whether or not the current driving mode of the host vehicle M is mode A or B (step S100). In step S100, when the current driving mode of the host vehicle M is not mode A or B, the mode decider 150 iterates the determination of step S100.

On the other hand, when it is determined that the current driving mode of the host vehicle M is mode A or B in step S100, the mode decider 150 acquires lane information output by the recognizer 130 (step S102). Also, the mode decider 150 determines whether or not the number of lanes included in the acquired lane information exceeds the first reference value (step S104). When it is determined that the number of lanes does not exceed the first reference value in step S104, the mode decider 150 returns the process to step S100.

On the other hand, when it is determined that the number of lanes exceeds the first reference value in step S104, the mode decider 150 changes the driving mode of the host vehicle M to mode C (step S106).

Subsequently, the mode decider 150 acquires lane information output by the recognizer 130 again (step S108). The processing of step S108 may be performed when a prescribed period of time has elapsed after the driving mode of the host vehicle M was changed to mode C in the processing of step S106. The prescribed period of time is, for example, a period of about several seconds [sec] to several tens of seconds [sec]. The prescribed period of time may be, for example, a period until the number of lanes recognized by the recognizer 130 becomes a different value.

Also, the mode decider 150 determines whether or not the number of lanes included in the lane information acquired again is less than or equal to the first reference value (step S110). When it is determined that the number of lanes is not less than or equal to the first reference value in step S110, the mode decider 150 returns the process to step S100. That is, the mode decider 150 maintains the changed current traveling mode (mode C).

On the other hand, when it is determined that the number of lanes is less than or equal to the first reference value in step S110, the mode decider 150 changes the driving mode of the host vehicle M to mode A or B (step S112) and returns the process to step S100.

In the above-described process, when the current driving mode of the host vehicle M is mode A or B, the mode decider 150 changes the driving mode of the host vehicle M to mode C when the number of lanes in a direction identical to the traveling direction of the host vehicle M that is currently traveling exceeds the first reference value. Thereby, the driver performs forward monitoring and grips the steering wheel 82 and can cope with changes in the surrounding environment. As a result, the automated driving control device 100 can perform appropriate control corresponding to a road structure.

### Second Embodiment

The mode decider 150 in the first embodiment changes the driving mode of the host vehicle M to mode C on the basis of the number of lanes recognized by the recognizer 130 when the host vehicle M is traveling in mode A or B. The mode decider 150 according to the second embodiment may be configured to further narrow down the number of lanes recognized by the recognizer 130 to the number of lanes near the host vehicle M to make a determination and change the driving mode to mode C. In this case, the mode decider 150 sets a range around the host vehicle M (hereinafter referred to as a peripheral range) as a range obtained by combining a range of a main lane including a travel lane in which the host vehicle M is traveling and ranges of peripheral distances in front of and behind the host vehicle M.

The mode decider 150 determines whether the current driving mode of the host vehicle M is mode A or B and whether or not the number of lanes included in the lane information exceeds the second reference value. Also, when the number of lanes exceeds the second reference value, the mode decider 150 changes the driving mode according to whether or not the number of lanes including the main lane and a lane in which there is a branch point from the main lane or a merging point to the main lane within the peripheral range exceeds the third reference value. The second reference value is, for example, a value of the number of lanes that are about several tens of lanes and the third reference value is, for example, a value of the number of lanes that are about several lanes. The second reference value and the third reference value may be fixed values like the first reference value of the first embodiment or may be determined in accordance with a situation in which the host vehicle M is currently traveling such as a speed at which the host vehicle M is traveling, the presence or absence of other vehicles traveling in the same travel lane or the main lane, or the number of main lanes.

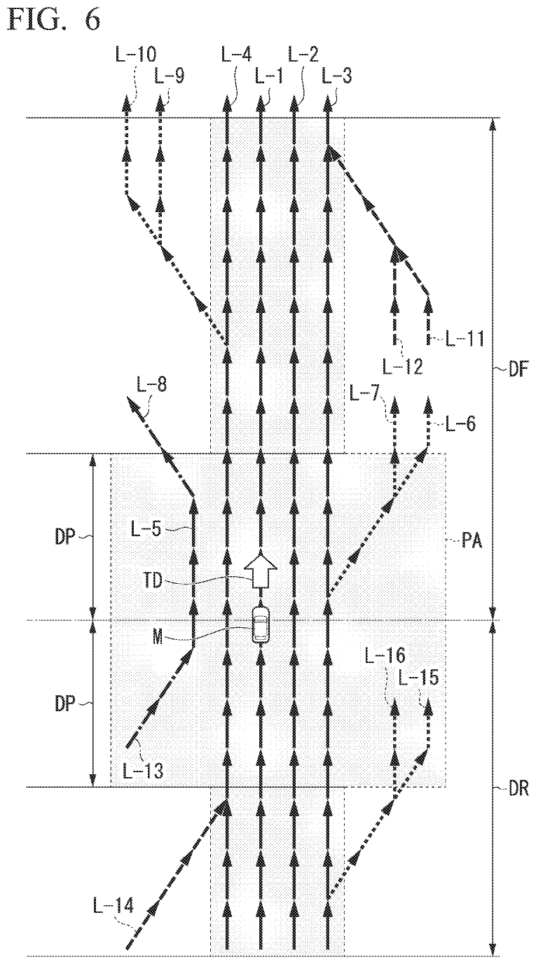

FIG. 6 is a diagram showing a case where a range of lanes recognized by the recognizer 130 is narrowed down to a peripheral range of the host vehicle M according to the second embodiment. Also, in FIG. 6, a series of arrows that are continuously connected indicate lanes. In FIG. 6, the peripheral distances DP in front of and behind the host vehicle M and the peripheral range PA are shown in the situation shown in FIG. 4 in the first embodiment. The peripheral distance DP is shorter than the forward reference distance DF and the rearward reference distance DR. For example, the peripheral distance DP is a distance from about one hundred meters [m] to several hundreds of meters [m]. In the situation shown in FIG. 6, the lanes L located within the peripheral range PA are lanes L-1 to L-5, which are main lanes including the travel lane of the host vehicle M, lanes L-6 to L-8, which are branch lanes in which a branch point is located in the range of the peripheral distance DP in front of the host vehicle M, and a lane L-13, which is a merging lane in which a merging point is located in the range of the peripheral distance DP behind the host vehicle M. The mode decider 150 changes the driving mode of the host vehicle M on the basis of the number of lanes that are lanes L located inside of the peripheral range PA.

### [Driving Mode Change Process]

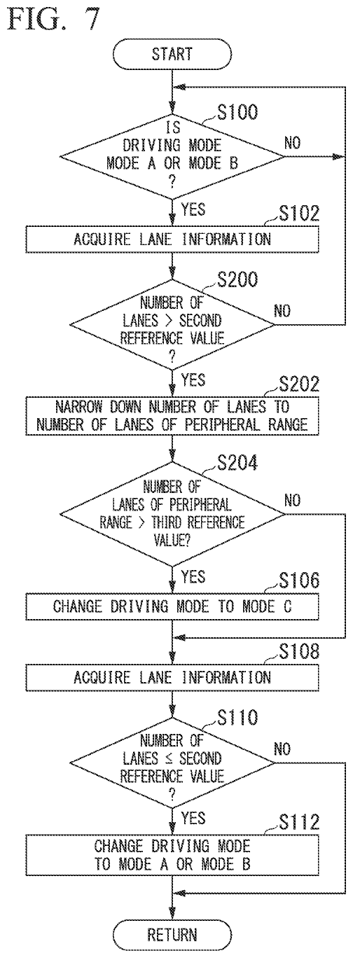

FIG. 7 is a flowchart showing an example of a flow of a process executed by the mode decider 150 according to the second embodiment. A change process of the present flowchart is also iteratively executed, for example, when the automated driving control device 100 is operating, like the change process of the first embodiment. The present flowchart includes a process similar to the change process of the first embodiment. Accordingly, the same step numbers are assigned to processing steps similar to those of the change process of the first embodiment in the present flowchart and the redundant description of the similar processing steps will be omitted.

In the change process of the second embodiment, the mode decider 150 determines whether or not the number of lanes included in the lane information acquired in step S102 exceeds the second reference value (step S200). When it is determined that the number of lanes does not exceed the second reference value in step S200, the mode decider 150 returns the process to step S100.

On the other hand, when it is determined that the number of lanes exceeds the second reference value in step S200, the mode decider 150 narrows down the number of lanes included in the lane information acquired in step S102 to the number of lanes of the peripheral range PA of the host vehicle M (step S202). The processing of step S202 is performed, for example, by extracting the lanes L within the peripheral range PA from the lanes L included in the lane information on the basis of lane classification information and lane position information included in the lane information or by instructing the recognizer 130 to recognize the lanes L within the peripheral range PA again and acquiring lane information from the recognizer 130.

Subsequently, the mode decider 150 determines whether or not the number of lanes in the peripheral range PA to which the number of lanes is narrowed down in step S202 exceeds the third reference value (step S204). When it is determined that the number of lanes in the peripheral range PA does not exceed the third reference value in step S204, the mode decider 150 moves the process to step S108.

On the other hand, when it is determined that the number of lanes within the peripheral range PA exceeds the third reference value in step S204, the mode decider 150 changes the driving mode of the host vehicle M to mode C (step S106).

Subsequently, the mode decider 150 performs the processing of steps S108 to S112 as in the change process of the first embodiment. At this time, the second reference value is used in the processing of step S110 in the change process of the second embodiment, but the third reference value may be used.

In the above-described process, the mode decider 150 of the second embodiment further determines whether or not the number of nearby lanes exceeds the third reference value in a case where the number of lanes in a direction identical to the traveling direction of the host vehicle M that is currently traveling exceeds the second reference value when the current driving mode of the host vehicle M is mode A or B and changes the driving mode of the host vehicle M to mode C when the number of nearby lanes exceeds the third reference value. Thereby, as in the change process of the first embodiment, the driver performs forward monitoring and grips the steering wheel 82 and can cope with changes in the surrounding environment. As a result, the automated driving control device 100 according to the second embodiment can perform appropriate control corresponding to a road structure as in the first embodiment.

In the change process of the second embodiment, the driving mode of the host vehicle M is changed from mode A or B to mode C when it is determined that the number of lanes L located inside of the ranges of the forward reference distance DF and the rearward reference distance DR recognized by the recognizer 130 exceeds the second reference value in step S200 and when it is determined that the number of lanes within the peripheral range PA exceeds the third reference value in step S204. However, for example, the mode decider 150 may be configured to change the driving mode of the host vehicle M from mode A or B to mode C when it is determined that the number of lanes exceeds the second reference value in step S200 and to further change the driving mode of the host vehicle M from mode C to mode D or E when it is determined that the number of lanes within the peripheral range PA exceeds the third reference value in step S204.

### Third Embodiment

The mode decider 150 in the first embodiment or the second embodiment changes the driving mode of the host vehicle M to mode C on the basis of the number of lanes recognized by the recognizer 130 when the host vehicle M is traveling in mode A or B. In place of (or in addition to) this, the mode decider 150 may change the driving mode to mode C using other lane information related to a lane recognized by the recognizer 130. As described above, when the lanes L located inside of the ranges of the forward reference distance DF and the rearward reference distance DR are recognized, the recognizer 130 also recognizes a classification of each lane L (a main lane, a branch lane, or a merging lane). Also, the recognizer 130 can output lane information including lane classification information to the mode decider 150. Thus, the mode decider 150 can change the driving mode to mode C on the basis of the number of branch lanes recognized by the recognizer 130, i.e., the number of branch points from the main lane, in place of or in addition to the number of lanes recognized by the recognizer 130.

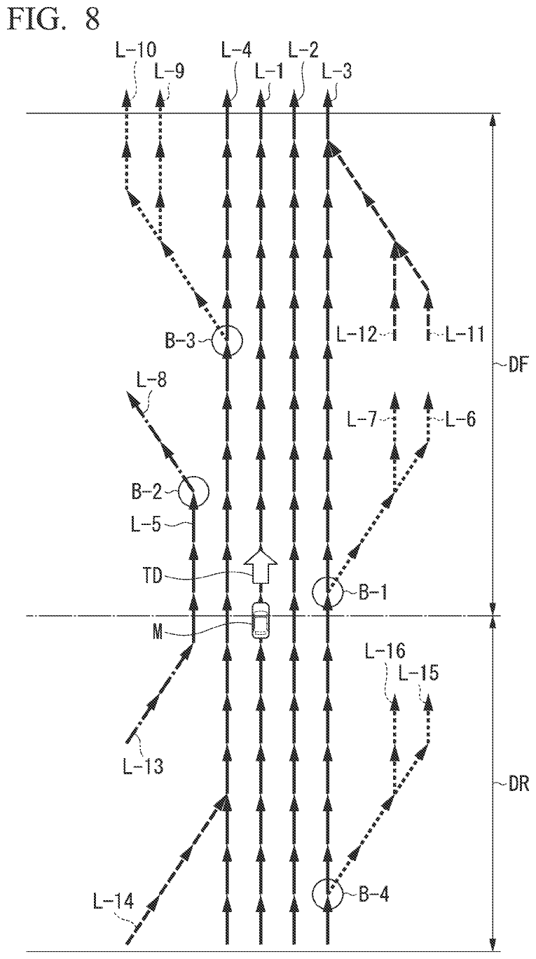

FIG. 8 is a diagram showing a branch lane (a branch point) recognized by the recognizer 130 according to the third embodiment. Also, in FIG. 8, a series of arrows that are continuously connected indicate lanes. In FIG. 8, a branch point B from the main lane recognized by the recognizer 130 is shown in the situation shown in FIG. 4 in the first embodiment. Even if the recognizer 130 recognizes the branch point B, the forward reference distance DF is longer than the rearward reference distance DR. When the recognizer 130 recognizes the branch point B, for example, the forward reference distance DF may be longer than the forward reference distance DF in the first embodiment.

In the situation shown in FIG. 8, the recognizer 130 recognizes lanes L-6 to L-within the range of the forward reference distance DF as branch lanes branching off from the main lane. Also, the recognizer 130 recognizes a branch point B-1 where the lanes L-6 and L-7 branch off from the main lane, a branch point B-2 where the lane L-8 branches off from the main lane, and a branch point B-2 where lanes L-9 and L-10 branch off from the main lane. Further, in the situation shown in FIG. 8, the recognizer 130 recognizes lanes L-15 and L-16 in the range of the rearward reference distance DR as branch lanes branching off from the main lane. Also, the recognizer 130 recognizes a branch point B-4 where the lanes L-15 and L-16 branch off from the main lane.

The recognizer 130 outputs lane information including information of each recognized branch point B to the mode decider 150. The information of the branch point B included in the lane information includes at least information of the number of branch points B (hereinafter referred to as the number of branches) that have been recognized. The information of the branch point B included in the lane information includes, for example, information indicating whether each recognized branch point B is a branch point B located in the range of either the forward reference distance DF or the rearward reference distance DR, information indicating a positional relationship related to the host vehicle M such as a distance from the position of the host vehicle M at each branch point B (which may include forward or rear information), and the like.

The mode decider 150 changes the driving mode of the host vehicle M on the basis of the number of branch lanes located in a range of the reference distance (a reference range) indicated in the information of the branch point B included in the lane information output by the recognizer 130. More specifically, the mode decider 150 determines whether the current driving mode of the host vehicle M is mode A or B and whether or not the number of branches indicated in the information of the branch point B included in the lane information exceeds a fourth reference value. The fourth reference value is, for example, a value of the number of locations that are about several locations. The fourth reference value may be a fixed value like the first reference value of the first embodiment or may be determined in accordance with a situation in which the host vehicle M is traveling such as a speed at which the host vehicle M is traveling, the presence or absence of other vehicles traveling in the same travel lane or the main lane, or the number of main lanes.

### [Driving Mode Change Process]

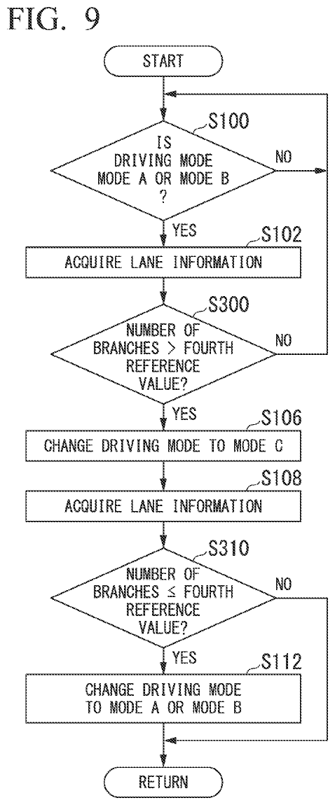

FIG. 9 is a flowchart showing an example of a flow of a process executed by the mode decider 150 according to the third embodiment. The change process of the present flowchart is also iteratively executed, for example, when the automated driving control device 100 is operating, like the change process of the first embodiment. Because the present flowchart includes a process similar to the change process of the first embodiment, the same step numbers are assigned to processing steps similar to those of the change process of the first embodiment and the redundant description thereof is omitted.

In the change process of the third embodiment, the mode decider 150 determines whether or not the number of branches indicated in the information of the branch points B included in the lane information acquired in step S102 exceeds the fourth reference value (step S300). When it is determined that the number of branches does not exceed the fourth reference value in step S300, the mode decider 150 returns the process to step S100.

On the other hand, when it is determined that the number of branches exceeds the fourth reference value in step S300, the mode decider 150 changes the driving mode of the host vehicle M to mode C (step S106).

Subsequently, the mode decider 150 acquires the lane information output by the recognizer 130 again (step S108). As in the change process of the first embodiment, the processing of step S108 in the change process of the third embodiment may be performed when a prescribed period of time has elapsed after the driving mode of the host vehicle M is changed to mode C in the processing of step S106. The prescribed period of time in the change process of the third embodiment may be, for example, a period until the number of branches recognized by the recognizer 130 becomes a different value.

Also, the mode decider 150 determines whether or not the number of branches indicated in the information of the branch points B included in the lane information acquired again is less than or equal to the fourth reference value (step S310). When it is determined that the number of branches is not less than or equal to the fourth reference value in step S310, the mode decider 150 returns the process to step S100. That is, in the change process of the third embodiment, the mode decider 150 also maintains the changed current traveling mode (mode C).

On the other hand, when it is determined that the number of branches is less than or equal to the fourth reference value in step S310, the mode decider 150 changes the driving mode of the host vehicle M to mode A or B (step S112) and returns the process to step S100.

In the above-described process, the mode decider 150 of the third embodiment changes the driving mode of the host vehicle M to mode C in a case where the number of branches in a direction identical to the traveling direction of the host vehicle M that is currently traveling exceeds the fourth reference value when the current driving mode of the host vehicle M is mode A or B. Thereby, as in the change process of the first embodiment, the driver performs forward monitoring and grips the steering wheel 82 and can cope with changes in the surrounding environment. As a result, the automated driving control device 100 according to the third embodiment can perform appropriate control corresponding to a road structure as in the first embodiment.

In the change process of the third embodiment, as in the change process of the first embodiment, the driving mode of the host vehicle M is changed from mode A or B to mode C when it is determined that the number of branches of branch points B located inside of the ranges of the forward reference distance DF and the rearward reference distance DR recognized by the recognizer 130 exceeds the fourth reference value in step S300. However, the mode decider 150 of the third embodiment may be configured to change the driving mode of the host vehicle M in two steps, for example, as in the second embodiment. That is, as in the change process of the second embodiment, the mode decider 150 of the third embodiment may be configured to change the driving mode of the host vehicle M from mode A or B to mode C in the first step and change the driving mode of the host vehicle M from mode C to mode D or E in the second step. In this case, it is only necessary for a method in which the recognizer 130 recognizes the number of branch points B or branches, a process of the mode decider 150, and the like to be equivalent to those in the case of the second embodiment described above.

As described above, according to the automated driving control device 100 of the embodiment, the recognizer 130 recognizes a lane (or a branch point) where other vehicles that is likely to be involved in the traveling of the host vehicle M are traveling. Also, in the automated driving control device 100 of the embodiment, the mode decider 150 changes the driving mode of the host vehicle M on the basis of information of lanes recognized by the recognizer 130 when the current driving mode of the host vehicle Mis mode A or B. Thereby, the automated driving control device 100 of the embodiment can perform appropriate control according to a road structure.

The embodiment described above can be represented as follows.

A vehicle control device including:
a storage device storing a program; and
a hardware processor,
wherein the hardware processor executes the program stored in the storage device to:
recognize a surrounding situation of the vehicle;
control steering, acceleration, and deceleration of the vehicle independently of an operation of a driver of the vehicle;
decide on a driving mode of the vehicle as one of a plurality of driving modes including a first driving mode and a second driving mode, wherein the second driving mode is a driving mode having a lighter task imposed on the driver than the first driving mode, and perform some of the plurality of driving modes including at least the second driving mode by controlling the steering, the acceleration, and the deceleration of the vehicle independently of the operation of the driver of the vehicle;
change the driving mode of the vehicle to a driving mode having a heavier task when a task related to the decided driving mode is not executed by the driver;
recognize an available travel lane in the same direction as the vehicle located inside of a reference range at the time of the recognition; and
change the driving mode of the vehicle from the second driving mode to the first driving mode on the basis of the number of recognized lanes when the driving mode of the vehicle is the second driving mode.

Although modes for carrying out the present invention have been described above using embodiments, the present invention is not limited to the embodiments and various modifications and substitutions can also be made without departing from the scope and spirit of the present invention.

### REFERENCE SIGNS LIST

1 Vehicle system
10 Camera
12 Radar device
14 LIDAR sensor
16 Physical object recognition device
40 Vehicle sensor
70 Driver monitor camera
80 Driving operation elements
82 Steering wheel
84 Steering grip sensor
100 Automated driving control device
120 First controller
130 Recognizer
140 Action plan generator
150 Mode decider
152 Driver state determiner
154 Mode change processor
160 Second controller

What is claim is:

1. A vehicle control device comprising:
a recognizer configured to recognize a surrounding situation of a vehicle;
a driving controller configured to control steering, acceleration, and deceleration of the vehicle independently of an operation of a driver of the vehicle; and
a mode decider configured to decide on a driving mode of the vehicle as one of a plurality of driving modes including a first driving mode and a second driving mode and change the driving mode of the vehicle to a driving mode having a heavier task when a task related to the decided driving mode is not executed by the driver, wherein the second driving mode is a driving mode having a lighter task imposed on the driver than the first driving mode and some of the plurality of driving modes including at least the second driving mode are controlled by the driving controller,
wherein the recognizer recognizes an available travel lane in the same direction as the vehicle located inside of a reference range, and
wherein the mode decider changes the driving mode of the vehicle from the second driving mode to the first driving mode on the basis of the number of lanes recognized by the recognizer when the driving mode of the vehicle is the second driving mode, and
wherein the mode decider changes the driving mode of the vehicle in the driving controller from the second driving mode to the first driving mode when the number of lanes exceeds a first reference value.

2. (canceled)

3. The vehicle control device according to claim 1, wherein the mode decider changes the driving mode in the driving controller from the second driving mode to the first driving mode when the number of lanes exceeds a second reference value and the number of lanes located inside of a range near the vehicle recognized by the recognizer exceeds a third reference value.

4. The vehicle control device according to claim 1, wherein the reference range includes a range from the vehicle to a forward reference distance in a forward direction and a range from the vehicle to a rearward reference distance in a rearward direction.

5. The vehicle control device according to claim 4, wherein the forward reference distance is longer than the rearward reference distance.

6. A vehicle control device comprising:
a recognizer configured to recognize a surrounding situation of a vehicle;
a driving controller configured to control steering, acceleration, and deceleration of the vehicle independently of an operation of a driver of the vehicle; and
a mode decider configured to decide on a driving mode of the vehicle as one of a plurality of driving modes including a first driving mode and a second driving mode and change the driving mode of the vehicle to a driving mode having a heavier task when a task related to the decided driving mode is not executed by the driver, wherein the second driving mode is a driving mode having a lighter task imposed on the driver than the first driving mode and some of the plurality of driving modes including at least the second driving mode are controlled by the driving controller,
wherein the recognizer recognizes a branch point in an available travel lane in the same direction as the vehicle located inside of a reference range, and
wherein the mode decider changes the driving mode of the vehicle from the second driving mode to the first driving mode when the driving mode of the vehicle is the second driving mode and the number of branch points recognized by the recognizer exceeds a fourth reference value.

7. The vehicle control device according to claim 1,
wherein the second driving mode is a driving mode in which at least gripping of an operation element for receiving a steering operation from the driver is not imposed, and
wherein the first driving mode is a driving mode in which at least one driving operation by the driver within the steering, the acceleration, and the deceleration of the vehicle is required or a driving mode in which gripping of the operation element by the driver is imposed.

8. A vehicle control method comprising:
recognizing, by a computer mounted in a vehicle, a surrounding situation of the vehicle;
controlling, by the computer, steering, acceleration, and deceleration of the vehicle independently of an operation of a driver of the vehicle;
deciding, by the computer, on a driving mode of the vehicle as one of a plurality of driving modes including a first driving mode and a second driving mode, wherein the second driving mode is a driving mode having a lighter task imposed on the driver than the first driving mode, and performing some of the plurality of driving modes including at least the second driving mode by controlling the steering, the acceleration, and the deceleration of the vehicle independently of the operation of the driver of the vehicle;
changing, by the computer, the driving mode of the vehicle to a driving mode having a heavier task when a task related to the decided driving mode is not executed by the driver;
recognizing, by the computer, an available travel lane in the same direction as the vehicle located inside of a reference range at the time of the recognition; and
changing, by the computer, the driving mode of the vehicle from the second driving mode to the first driving mode on the basis of the number of recognized lanes when the driving mode of the vehicle is the second driving mode; and
changing, by the computer, the driving mode from the second driving mode to the first driving mode when the number of lanes exceeds a first reference value.

9. A vehicle control method comprising:
recognizing, by a computer mounted in a vehicle, a surrounding situation of the vehicle;
controlling, by the computer, steering, acceleration, and deceleration of the vehicle independently of an operation of a driver of the vehicle;
deciding, by the computer, on a driving mode of the vehicle as one of a plurality of driving modes including a first driving mode and a second driving mode, wherein the second driving mode is a driving mode having a lighter task imposed on the driver than the first driving mode, and performing some of the plurality of driving modes including at least the second driving mode by controlling the steering, the acceleration, and the deceleration of the vehicle independently of the operation of the driver of the vehicle;
changing, by the computer, the driving mode of the vehicle to a driving mode having a heavier task when a task related to the decided driving mode is not executed by the driver;
recognizing, by the computer, a branch point in an available travel lane in the same direction as the vehicle located inside of a reference range at the time of the recognition; and
changing, by the computer, the driving mode of the vehicle from the second driving mode to the first driving mode when the driving mode of the vehicle is the second driving mode and the number of recognized branch points exceeds a fourth reference value.

10. A non-transitory computer-readable storage medium storing a program for causing a computer mounted in a vehicle to:
recognize a surrounding situation of the vehicle;
control steering, acceleration, and deceleration of the vehicle independently of an operation of a driver of the vehicle;
decide on a driving mode of the vehicle as one of a plurality of driving modes including a first driving mode and a second driving mode, wherein the second driving mode is a driving mode having a lighter task imposed on the driver than the first driving mode, and perform some of the plurality of driving modes including at least the second driving mode by controlling the steering, the acceleration, and the deceleration of the vehicle independently of the operation of the driver of the vehicle;
change the driving mode of the vehicle to a driving mode having a heavier task when a task related to the decided driving mode is not executed by the driver;
recognize an available travel lane in the same direction as the vehicle located inside of a reference range at the time of the recognition;
change the driving mode of the vehicle from the second driving mode to the first driving mode on the basis of the number of recognized lanes when the driving mode of the vehicle is the second driving mode; and
change the driving mode from the second driving mode to the first driving mode when the number of lanes exceeds a first reference value.

11. A non-transitory computer-readable storage medium storing a program for causing a computer mounted in a vehicle to:
recognize a surrounding situation of the vehicle;
control steering, acceleration, and deceleration of the vehicle independently of an operation of a driver of the vehicle;
decide on a driving mode of the vehicle as one of a plurality of driving modes including a first driving mode and a second driving mode, wherein the second driving mode is a driving mode having a lighter task imposed on the driver than the first driving mode, and perform some of the plurality of driving modes including at least the second driving mode by controlling the steering, the acceleration, and the deceleration of the vehicle independently of the operation of the driver of the vehicle;
change the driving mode of the vehicle to a driving mode having a heavier task when a task related to the decided driving mode is not executed by the driver;
recognize a branch point in an available travel lane in the same direction as the vehicle located inside of a reference range at the time of the recognition; and
change the driving mode of the vehicle from the second driving mode to the first driving mode when the driving mode of the vehicle is the second driving mode and the number of recognized branch points exceeds a fourth reference value.
